(19) United States
(12) Patent Application Publication
(10) Pub. No.: US 2015/0014111 A1
(43) Pub. Date: Jan. 15, 2015

(54) ONE-WAY RESISTANCE ROLL-UP APPARATUS

(71) Applicant: NIEN MADE ENTERPRISE CO., LTD., Taichung (TW)

(72) Inventor: De-Jun Zhang, Taichung (TW)

(21) Appl. No.: 13/942,127

(22) Filed: Jul. 15, 2013

(51) Int. Cl. F16D 41/12

(52) U.S. Cl. CPC F16D 41/12
USPC 192/45.1

(57) ABSTRACT

A roll-up apparatus, which provides a unidirectional resistance, includes an outer barrel, an inner barrel, damping oil, a clutch device, and a driving device. The outer and the inner barrels each has a concentric-circle structure therein. The inner barrel has first ratchet teeth. The outer barrel is fitted to the inner barrel, and the concentric-circle structures are engaged. The damping oil is received in a space between the concentric-circle structures. The clutch device has second ratchet teeth to disengage and engage the first ratchet teeth of the inner barrel when the clutch device is moved to a first position and a second position. The driving device moves the clutch device between the first position and the second position.

### BACKGROUND OF THE INVENTION

1. Technical Field

The present invention relates to a roll-up apparatus, and more particularly to a roll-up apparatus, which provides a unidirectional resistance.

2. Description of Related Art

A retractable curtain member, such as the blanket of window covering or the screen for a projector, is able to be rolled up when it is not in use. Typically, the retractable curtain member is provided with a weight rod at a bottom side thereof and a roll-up apparatus to roll the curtain member up. Sometime, the weight rod might hit the roll-up apparatus when the retractable curtain member is rolled up in a fast speed. It will damage the roll-up apparatus.

To fix this problem, an improved roll-up apparatus is provided with a resistance device to slow down the curtain member when it is rolled up. The conventional resistance devices usually are very complex, and they are hard to make and repair. Noise is the common problem in the conventional resistance devices. The conventional resistance devices usually are provided with a gearbox where the noise comes from. Except for the noise, the teeth of the gears in the gearbox will be broken after a long time of use. Viscous liquid is used in the gearbox, and sometimes an impeller in the viscous liquid is used for resistance purpose. However, it will slow down the curtain member in both retracting and in extending, which means that the curtain member will be extended slowly, and that is not desirable.

Therefore, the conventional retractable curtain member still needs to be improved.

### BRIEF SUMMARY OF THE INVENTION

In view of the above, the primary objective of the present invention is to provide a roll-up apparatus, which may slow down a curtain member only when it is rolled up, and reduce the noise.

In order to achieve the objective of the present invention, a roll-up apparatus includes an outer barrel, an inner barrel, damping oil, a clutch device, and a driving device. The outer and the inner barrels each has an open end and a closed end, and has a concentric-circle structure therein. The inner barrel further has first ratchet teeth on the closed end. The outer barrel is fitted to the inner barrel, and the concentric-circle structures in the outer and the inner barrels are engaged. The damping oil is received in a space between the concentric-circle structures. The clutch device has second ratchet teeth to disengage the first ratchet teeth of the inner barrel when the clutch device is moved to a first position and to engage the first ratchet teeth of the inner barrel when the clutch device is moved to a second position. The driving device moves the clutch device between the first position and the second position.

With such design, the damping oil provides the inner barrel a resistance, and the clutch device is controllable to transmit the resistance to the driving device when the driving device is turned in one direction or disengage the resistance power when the driving device is turned in an opposite direction. This design will reduce the noise as well.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the window blind equipped with the roll-up apparatus of a preferred embodiment of the present invention;

FIG. 2 is an exploded view of the window blind equipped with the roll-up apparatus of the preferred embodiment of the present invention;

FIG. 3 and FIG. 4 are exploded views of the roll-up apparatus of the preferred embodiment of the present invention;

FIG. 5 is a front view of the roll-up apparatus of the preferred embodiment of the present invention;

FIG. 6 is a sectional view in the 6-6 line of FIG. 5;

FIG. 7 is a sectional view in the 7-7 line of FIG. 5;

FIG. 8 is a front view of the preferred embodiment of the present invention, showing the disengaged clutch device; and

FIG. 9 is a front view of the preferred embodiment of the present invention, showing the engaged clutch device.

### DETAILED DESCRIPTION OF THE INVENTION

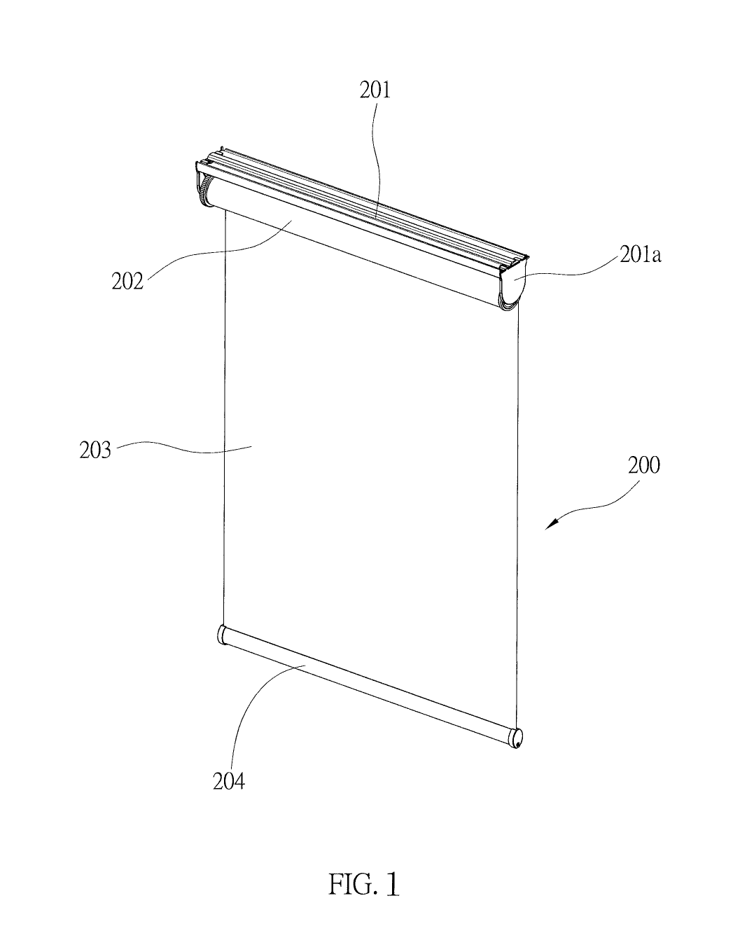

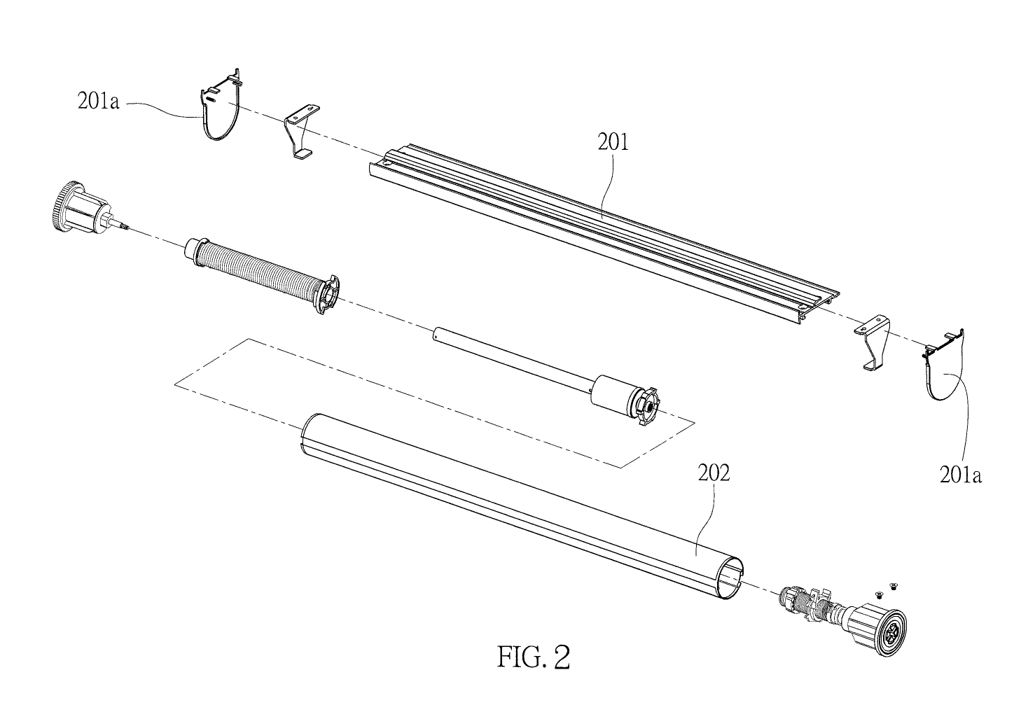

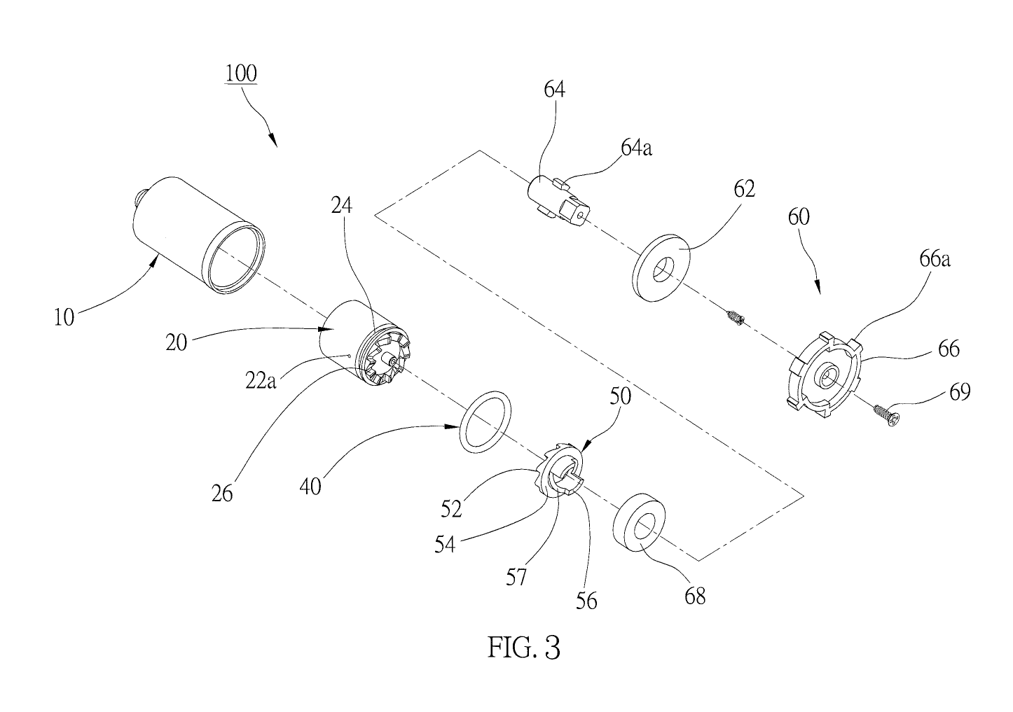

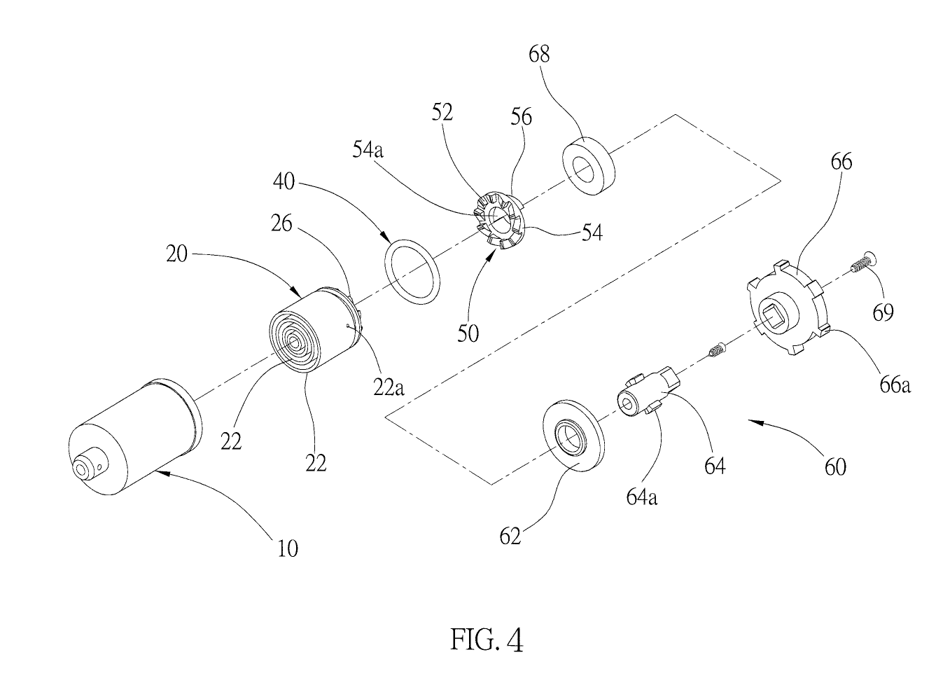

As shown in FIG. 1 to FIG. 4, a roll-up apparatus 100 of the preferred embodiment of the present invention, which is used to roll up a curtain member, such as a blanket of a window covering or a screen for a projector. FIG. 1 shows a window blind 200, having a headrail 201, a reel 202, a blanket 203, and the roll-up apparatus 100 (as shown in FIG. 3 and FIG. 4). The headrail 201 is hollow, and has two lids 201a at opposite ends. The reel 202 is received in the headrail 201. Opposite ends of the blanket 203 are fixed to the reel 202 and a weight rod 204. The roll-up apparatus 100 is received in the reel 202 to slow down the blanket 203 when it is rolled up. The roll-up apparatus 100 includes an outer barrel 10, an inner barrel 20, damping oil 30, an oil seal 40, a clutch device 50, and a driving device 60.

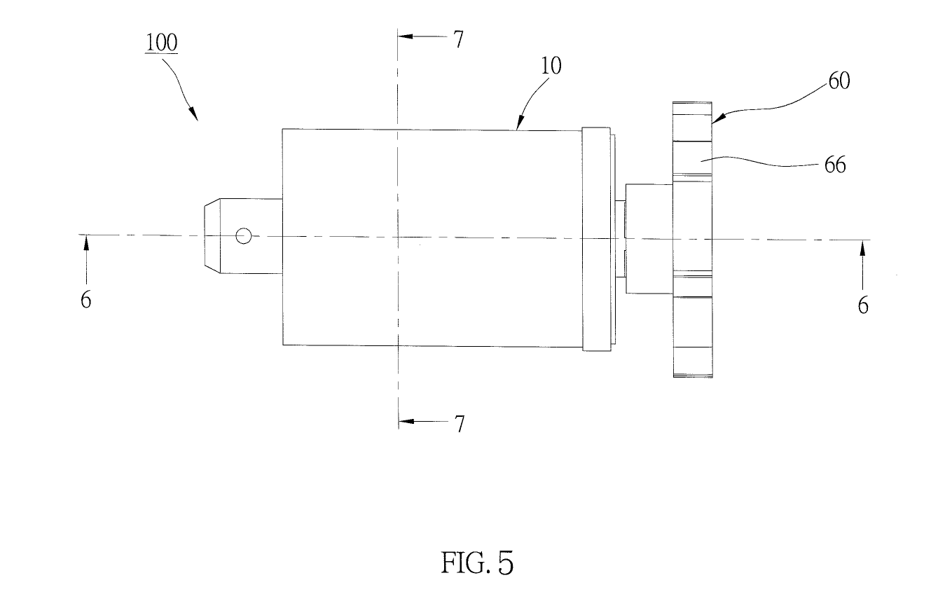

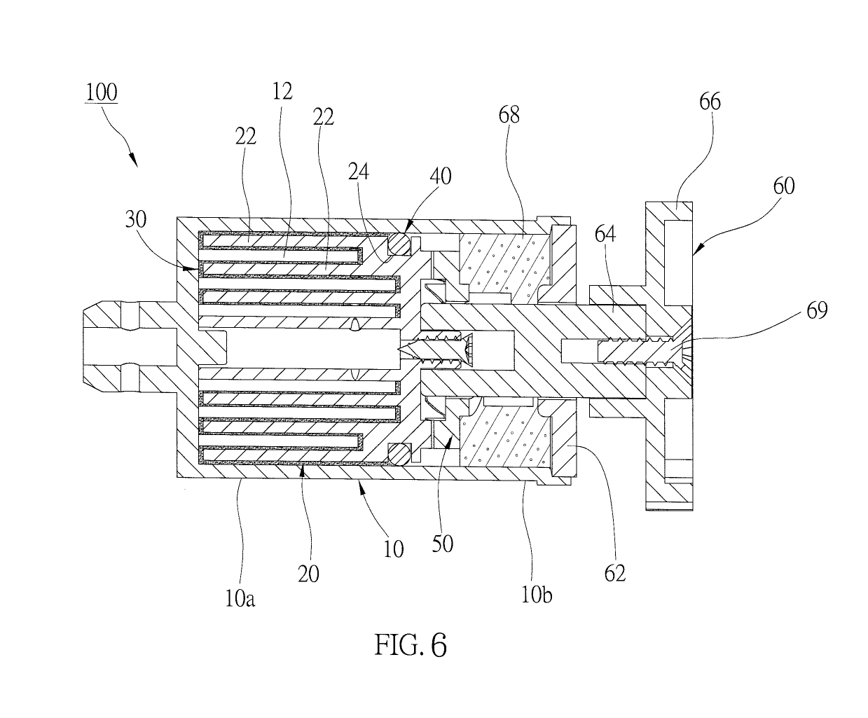

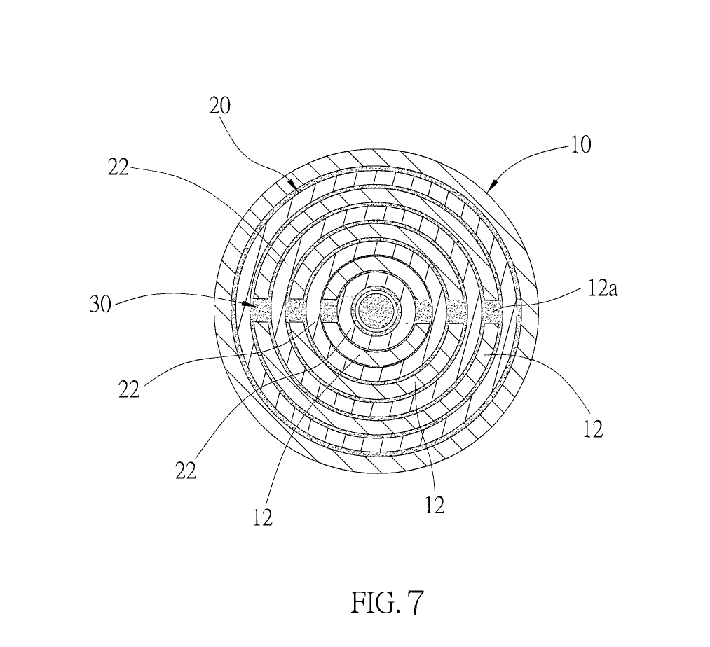

The outer barrel 10 and the inner barrel 20 each has an open end and a closed end at opposite sides. As shown in FIGS. from FIG. 5 to FIG. 7, the outer barrel 10 has a front section 10a and a rear section 10b, and has a first concentric-circle structure in the front section 10a. The first concentric-circle structure has a plurality of annular walls 12, which have the same center of circle and different diameters. The inner barrel 20 has a second concentric-circle structure therein, which has plurality of annular walls 22, and the annular walls 22 have the same center of circle and different diameters. The diameters of the annular walls 22 are different from that of the annular walls 12. The outer barrel 10 is fitted to the inner barrel 20. The annular walls 22 are received in spaces between the annular walls 12, and so do the annular walls 12, and there exists some space between the annular walls 12 of the outer barrel 10 and the annular walls 22 of the inner barrel 20.

The annular walls 12 of the outer barrel 10 are provided with slots 12a, and the annular walls 22 of the inner barrel 20 are provided with bores 22a. Air exists between the outer barrel 10 and the inner barrel 20 may escape via the slots 12a and the bores 22a when the outer barrel 10 is fitted to the inner barrel 20. Therefore, the engagement of the outer barrel 10 and the inner barrel 20 will be easier. The quantity and location of the slots 12a and the bores 22a are adjustable according to the requirement. The annular walls 12 of the outer barrel 10 could be replaced with bores, and the annular walls 22 of the inner barrel 20 could be replaced with slots, or both of them can be are provided with slots or bores. After engagement, the outer barrel 10 is not able to rotate, and the inner barrel 20 is free to rotate.

The engaged outer and inner barrels 10, 20 are filled with the damping oil 30. The damping oil 30 provides the inner barrel 20 a resistance to slow down the rotation of the inner barrel 20. The oil seal 40 is mounted between the outer barrel 10 and the inner barrel 20 to prevent a leakage of the damping oil 30. Preferably, the inner barrel 20 is provided with a recess 24 on an outer side thereof to receive the oil seal 40. The bores 22a on the out annular wall 22 are located between the open end of the inner barrel 20 and the oil seal 40.

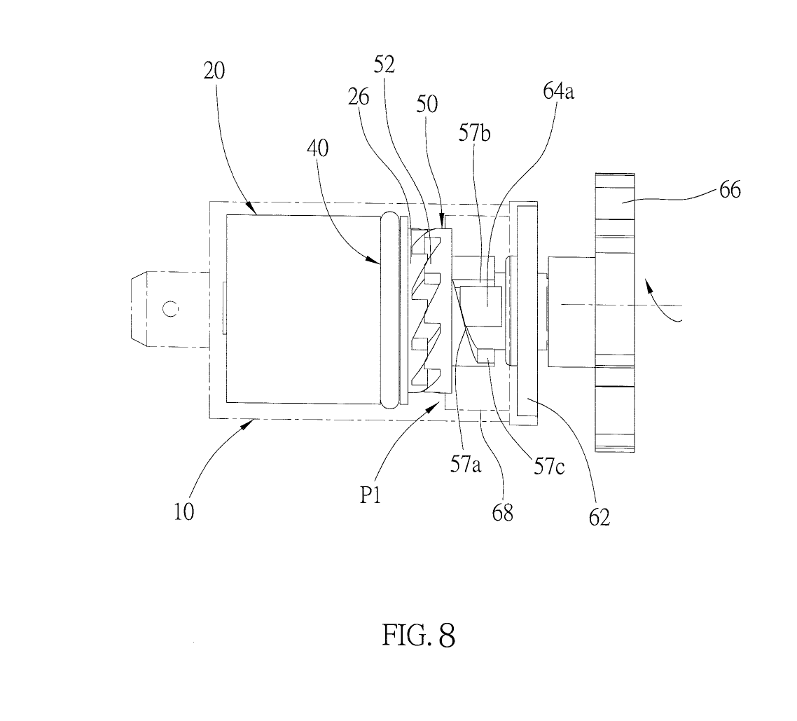

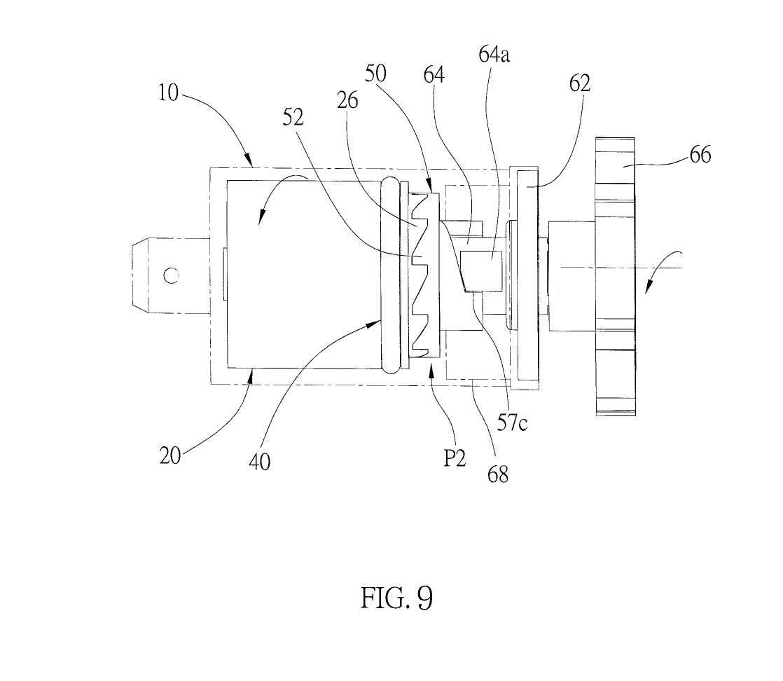

The inner barrel 20 is provided with first ratchet teeth 26 on the closed end thereof. The clutch device 50 is provided with second ratchet teeth 52. The driving device 60 moves the clutch device 50 to engage and disengage the second ratchet teeth 52 with the first ratchet teeth 26. The clutch device 50 has a disk 54 and a tube 56. The disk 54 has a bore 54a at a center and the second ratchet teeth 52 surrounding the bore 54a. The tube 56 is connected to the disk 54 at a side opposite to the second ratchet teeth 52, and is communicated with the bore 54a. It is preferable that clutch device 50 is a unity. The tube 56 has two slots 57, as shown in FIG. 8, each of the slots 57 has an inclined face 57a, a first face 57b at a lateral side of the slot 57, which is connected to a low end of the inclined face 57a, and a second face 57c at another lateral side of the slot 57, which is connected to a high end of the inclined face 57a. The quantity of the slots 57 can increase or decrease according to the requirement.

The driving device 60 has a lid 62, a shaft 64, a gear 66, and a flexible member 68. The lid 62 is fixed to the open end of the outer barrel 10. One end of the shaft 64 passes through the lid 62, the tube 56, and the bore 54a of the disk 54. The gear 66 is connected to the other end of the shaft 64, and fixed by a bolt 69. The gear 64 has teeth 66a at a circumference thereof, and the teeth 66a engage the reel 202 (not shown). Therefore, rotation of the reel 202 for retracting or extending the blanket 203 may drive the gear 66 to turn together. The flexible member 68 is provided between the clutch device 50 and the lid 62. In an embodiment, the flexible member 68 is a ring made of PU foam.

The shaft 64 of the driving device 60 has two protrusions 64a, which are received in the slots 57 of the tube 56 and against the inclined faces 57a respectively. As shown in FIG. 8, while the gear 66 rotates clockwise (when the blanket 203 is lowered), the protrusion 64a moves to the low end of the inclined face 57a and touches the first face 57b. There will be a space for the clutch device 50 to leave the inner barrel 20 and disengage the second ratchet teeth 52 with the first ratchet teeth 26. We define that as the clutch device 50 is moved to a first position P1, and rotation of the gear 66 does not turn the inner barrel 20. At this time, the resistance of the inner barrel 20 is cut off, and the blanket 203 is lowered without the resistance of the inner barrel 20 because of the damping oil 30.

While the gear 66 rotates counterclockwise to roll the blanket 203 up, the protrusions 64a move to the high end of the inclined face 57a and touch the second face 57c. The clutch device 50 will be forced to get close to inner barrel 20 and therefore engage the second ratchet teeth 52 with the first ratchet teeth 26. We define that as the clutch device 50 is moved to a second position P2, and rotation of the gear 66 will turn the inner barrel 20. At this time, the resistance of the inner barrel 20 is transmitted to the gear 66 through the clutch device 50 and the shaft 64 to slow down the blanket 203 when it is rolled up.

The PU foam of the flexible member 68 serves both functions of absorbing noise of the roll-up apparatus 100 and urging the clutch device 50 to make the first and the second ratchet teeth 26 and 52 engage.

It must be pointed out that the embodiments described above are only some preferred embodiments of the present invention. All equivalent structures which employ the concepts disclosed in this specification and the appended claims should fall within the scope of the present invention.

What is claimed is:

1. A roll-up apparatus, comprising:
an outer barrel having an open end and a closed end at opposite sides, and having a first concentric-circle structure therein;
an inner barrel having an open end and a closed end at opposite sides, and having a second concentric-circle structure therein and first ratchet teeth on the closed end;
wherein the outer barrel is fitted to the inner barrel to engage the first concentric-circle structure with the second concentric-circle structure;
damping oil received in a space between the first concentric-circle structure and the second concentric-circle structure;
a clutch device having second ratchet teeth;
a driving device for moving the clutch device between a first and a second position, wherein the second ratchet teeth of the clutch device is disengaged with the first ratchet teeth of the inner barrel when the clutch device is moved to the first position, and the second ratchet teeth of the clutch device is engaged with the first ratchet teeth of the inner barrel when the clutch device is moved to the second position.

2. The roll-up apparatus of claim 1, wherein the clutch device has a disk and a tube; the disk has a bore; the second ratchet teeth are on the disk and surround the bore; the tube is connected to the disk, and is opposite to the second ratchet teeth; the tube is communicated with the bore; the tube has a slot; the driving device has a shaft and a gear; the shaft passes through the tube and the bore of the disk; the shaft has a protrusion; the protrusion engages the slot of the tube; and the gear is fixed to the shaft.

3. The roll-up apparatus of claim 2, wherein the tube has an inclined face on a bottom of the slot, a first face on a lateral side of the slot, which is connected to a low end of the inclined face, and a second face on an opposite lateral side of the slot, which is connected to a high end of the inclined face; the protrusion of the shaft moves on the inclined face when the gear is turned; and the protrusion touches the first face when the clutch device is moved to the first position, and touches the second face when the clutch device is moved to the second position.

4. The roll-up apparatus of claim 3, wherein the driving device has a lid and a flexible member; the lid is connected to the open end of the outer barrel; and the flexible member is between the clutch device and the lid.

5. The roll-up apparatus of claim 4, wherein the flexible member is a foam.

6. The roll-up apparatus of claim 1, further comprising an oil seal between the outer barrel and the inner barrel.

7. The roll-up apparatus of claim 1, wherein the first concentric-circle structure of the outer barrel has a plurality of annular walls; the annular walls have the same center of circle and different diameters; and each annular wall has at least a slot.

8. The roll-up apparatus of claim 1, wherein the second concentric-circle structure of the inner barrel has a plurality of annular walls; the annular walls have the same center of circle and different diameters; and each annular wall has at least a slot.

9. The roll-up apparatus of claim 1, wherein the second concentric-circle structure of the inner barrel has a plurality of annular walls; the annular walls have the same center of circle and different diameters; and each annular wall has at least a bore.

10. The roll-up apparatus of claim 7, wherein the second concentric-circle structure of the inner barrel has a plurality of annular walls; the annular walls have the same center of circle and different diameters; and each annular wall has at least a slot.

11. The roll-up apparatus of claim 7, wherein the second concentric-circle structure of the inner barrel has a plurality of annular walls; the annular walls have the same center of circle and different diameters; and each annular wall has at least a bore.
